(19) United States
(12) Patent Application Publication
(10) Pub. No.: US 2003/0217571 A1
(43) Pub. Date: Nov. 27, 2003

(54) Tamper resistant lock shield for valve

(76) Inventors: William F. Turnau III, Canton, MI (US); Steven J. Tokarz, Canton, MI (US)

Correspondence Address: Edgar A. Zarins, Masco Corporation, 21001 Van Born Road, Taylor, MI, 48180, US

(21) Appl. No.: 10/224,869

(22) Filed: Aug. 21, 2002

Related U.S. Application Data
(60) Provisional application No. 60/383,215, filed on May 24, 2002.

(51) Int. Cl. G05G 5/00; F16K 35/00

(52) U.S. Cl. 70/175

(57) ABSTRACT

A shield for preventing unauthorized manipulation of a fluid valve which can be retrofitted by the end user in place of the valve handle. The shield assembly includes a cylindrical shield member which is held on the valve assembly by a key adapter fastened to the valve stem in place of the valve handle. The key adapter includes a cavity for matingly receiving the valve stem such that rotation of the key adapter is transmitted to the valve stem for operation of the valve. The key adapter is positioned within the cylindrical shield preventing manipulation with a hand tool. The key adapter has a specially configured knob which is matingly engaged by a key for rotation of the key adapter and valve stem to selectively move the valve between its open and closed positions.

### RELATED APPLICATIONS

This application claims priority from U.S. Provisional Application No. 60/383,215 filed May 24, 2002.

### BACKGROUND OF THE INVENTION

I. Field of the Invention

This invention relates to a shield for preventing unauthorized manipulation of a valve such as a quarter-turn stop valve and, in particular, to a lock shield which may be retrofitted to a standard valve in place of the handle to require a key for operation.

II. Description of the Prior Art

Valve assemblies are widely used to control the flow and supply of fluids through a fluid line. Typical valves include a valve body seated within a housing to control flow through the housing. A valve stem extends from the valve body to facilitate control of the valve. A valve handle connected to the valve stem permits convenient manipulation of the valve. Such valves can control the volume of flow through the line as it is rotated several times or can merely act as a stop valve requiring only a quarter turn to move between open and closed positions.

In certain settings, it is desirable to prevent unauthorized manipulation of the valve whether by inadvertence or tampering. A standard valve may be easily manipulated using the manual handle attached to the valve. In the past, when restrictions on use of the valve were needed, the handle would be removed requiring replacement to manipulate the valve. In other situations a lockout device was placed over the valve handle to prevent manipulation of the handle.

### SUMMARY OF THE PRESENT INVENTION

The present invention overcomes the disadvantages of the prior known lockout devices for valve assemblies by providing a shield retrofittable in place of the valve handle which prevents manipulation of the valve except with a specially configured key.

The valve assembly of the present invention includes a valve member selectively rotatable within a valve housing to control the flow of fluid through the housing and the fluid line. The valve member has a valve stem which extends externally of the housing. In the typical installation, a valve handle will be secured to the valve stem for rotation of the valve within the housing to control the fluid flow. However, such a handle is manipulable by any individual. To prevent unauthorized manipulation of the valve, means must be applied which prevents rotation of the valve stem and valve member.

In order to attach the lock shield of the present invention, the conventional handle must be removed from the valve assembly exposing the valve stem which has an axial bore. A lock shield is first mounted to the valve assembly to encapsulate the valve stem. The lock shield has a cylindrical configuration with an end wall at one end and an open second end. The end wall has an aperture configured to receive the valve stem. The aperture in the end wall of the shield may be configured such that the shield will rotate freely around the stem or may cooperate with the stop flange and remain stationary.

A key adapter is inserted into the shield and matingly mounted to the valve stem. The key adapter has an axial throughbore for receiving a fastener which is secured to the bore of the valve stem. The key adapter includes a cavity configured to matingly receive the valve stem such that rotation of the key adapter is transmitted to the valve stem. The key adapter captures the end wall of the shield against the valve and sits within the shield to prevent manipulation using a wrench or other conventional tool. The key adapter has a specially configured knob which is engageable by a similarly configured key for selective manipulation of the valve. Thus, the lock shield of the present invention allows an end user to convert a conventional valve with a handle to one that requires a key to operate for tamper resistance.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is an exploded view of a lock shield embodying the present invention;

FIG. 2 is a partial cross-sectional view of the lock shield mounted to a straight valve;

FIGS. 3a/3b are perspective views of the key adapter;

FIGS. 4a/4b are perspective views of the shield cylinder;

FIG. 5 is an exploded view of the lock shield with an angled valve; and

FIG. 6 is a partial cross-sectional view thereof.

### DETAILED DESCRIPTION OF A PREFERRED EMBODIMENT OF THE PRESENT INVENTION

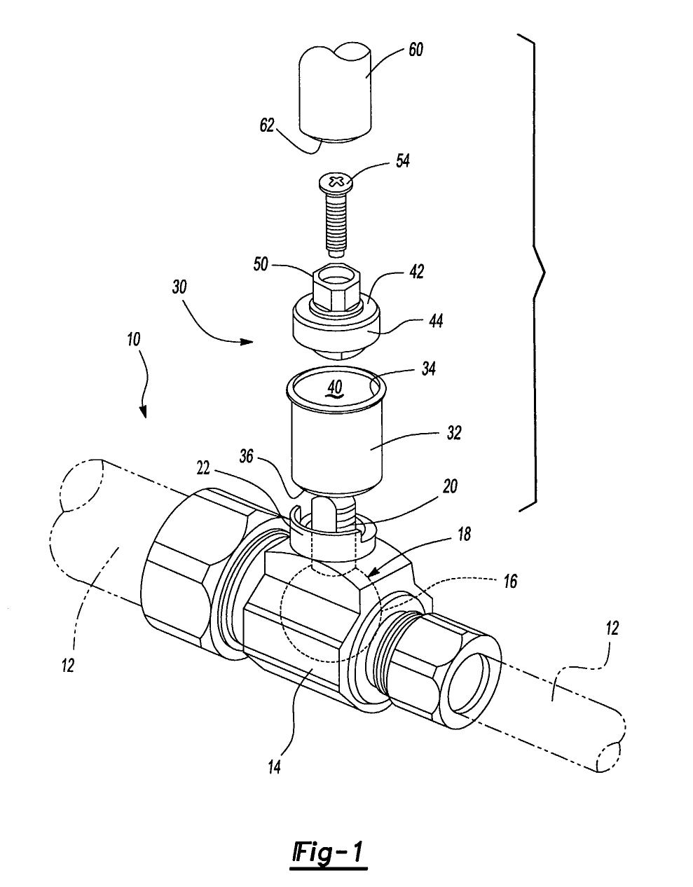

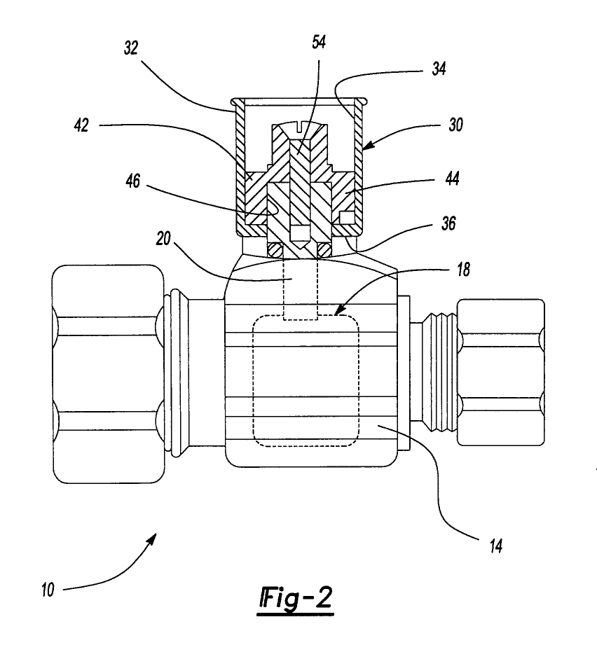

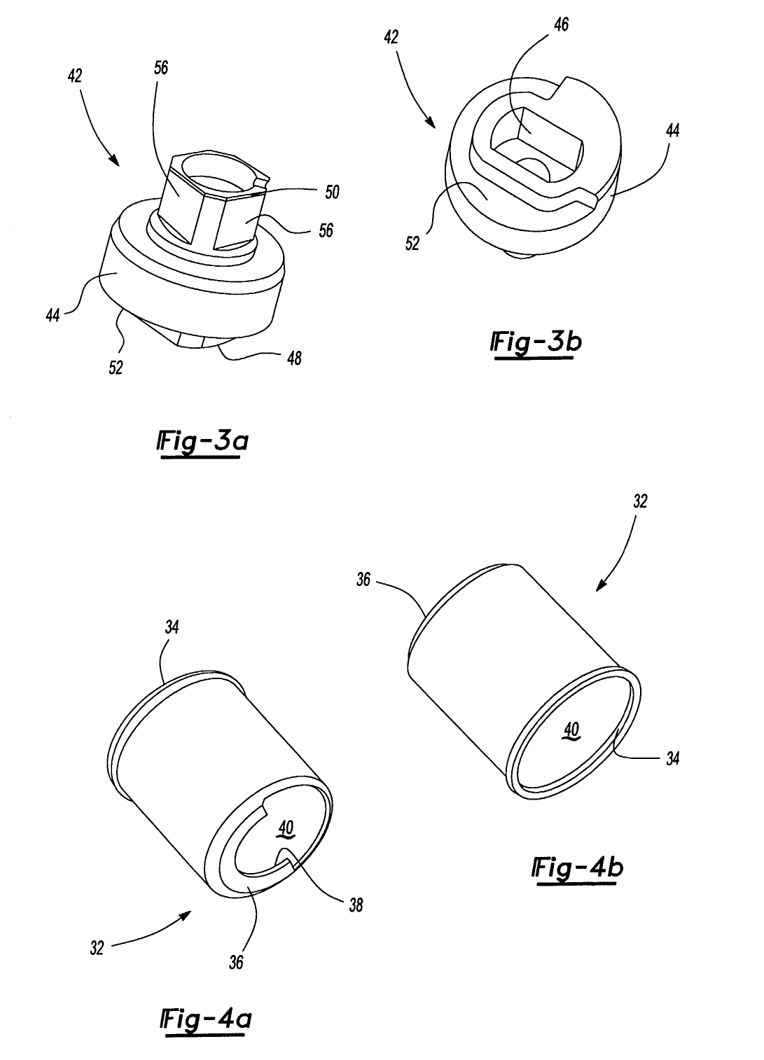

Referring first to FIGS. 1 and 2, there is shown a valve assembly 10 adapted to control the flow of fluid through the fluid lines 12. The present invention will be shown and described in connection with a quarter turn stop valve 10 although it is to be understood that the present invention can be adapted to different valve types to prevent unauthorized operation of the valve 10. The valve assembly 10 includes a housing 14 with a fluid passageway 16 fluidly connecting the lines 12. Rotatably disposed within the housing 14 is a valve member 18 for selectively controlling flow through the fluid passageway 16. In the quarter turn valve, the valve member 18 has a throughbore which conducts or blocks flow through the valve 10 depending upon the orientation of the valve member 18. A valve stem portion 20 connected to the valve member 18 extends through a wall of the housing 14 for manipulation of the valve member 18 outside of the housing 14. In the typical valve assembly 10, a valve handle (not shown) will be fastened to the valve stem 20 to facilitate manipulation of the valve member 18 to control the flow of fluid through the valve assembly 10.

The lock shield 30 of the present invention is mounted to the valve 10 following removal of the valve handle to deter unauthorized manipulation of the valve 10. In some instances, it may be desirable to prevent unauthorized opening or closing of the valve 10 or, in adjustable flow rate valves, adjustment of a specific setting. The lock shield 30 of the present invention deters manipulation by hand or by certain tools thereby providing some control over the operation of the valve 10.

The lock shield 30 includes a cylindrical shield member 32 having an open first end 34 and an end wall 36 formed at a second end thereof. The end wall 36 includes an aperture 38 configured to receive the valve stem 20 therethrough. Upon mounting of the shield member 32 on the valve 10, the valve stem 20 will extend through the end wall 36 into the interior 40 of the shield member 32. The end wall aperture 38 may also be configured to accommodate a stop flange 22 on the valve 10 or any similar structure of the valve member 10.

Fastened to the valve stem 20 and disposed within the shield member 32 is a key adapter 42. The key adapter 42 has a base 44 with a cavity 46 formed in the bottom 48 thereof and a nose or knob 50 extending upwardly from the base 44. The bottom cavity 46 is configured to matingly engage the stem 20 such that rotation of the key adapter 42 is transmitted to the valve stem 20 for operation of the valve 10. The bottom 48 may also include a cut-away 52 to accommodate the stop flange 22 on the valve 10. The base 44 is configured to capture the end wall 36 of the shield member 32 against the valve housing 14 as shown in FIG. 2 to prevent removal of the shield 32 without first removing the key adapter 42. Preferably, the key adapter 42 is secured to the stem 20 by a fastener 54 extending through the key adapter 42 to threadably engage the stem 20. In many instances, the fastener 54 used to secure the valve handle can be used to secure the key adapter 42.

The knob 50 of the key adapter 42 has an external configuration conducive to being rotatably manipulated by a key 60 having a cavity 62 configured to matingly engage the knob 50. The knob 50 and cavity 62 must be provided with identical configurations although that configuration may be changed between shield assemblies to provide unique keying. The external configuration of the knob 50 will include at least one flat 56 to facilitate rotation of the knob 50. Moreover, the external diameter of the key 60 will be less than the inner diameter of the shield 32 to permit insertion of the key 60 into the shield 32 to engage the key adapter 42.

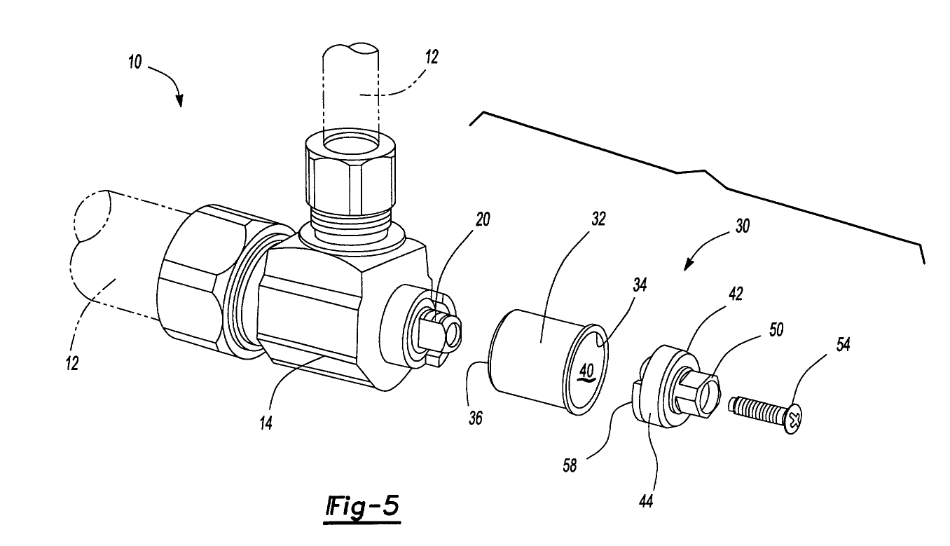

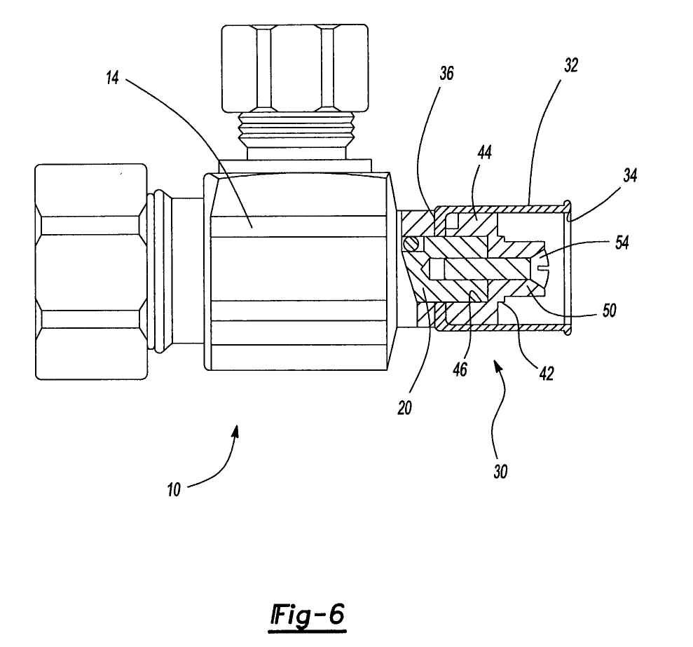

FIGS. 5 and 6 illustrate an alternative embodiment of the valve assembly 10 showing an angled valve with the fluid lines 12 disposed at 90° from each other. The valve stem 20 extends through an end wall of the valve housing 14 to which the shield assembly 30 may be mounted in a manner as disclosed.

The shield assembly 30 of the present invention may be retrofitted to a standard valve 10 by the end user upon removal of the valve handle. The shield member 32 is positioned over the valve stem 20 and the key adapter 42 is inserted into the shield 32 until the valve stem 20 seats within the cavity 46 of the key adapter 42. The fastener 54 is inserted through the key adapter 42 to threadably engage the stem 20. The key adapter 42 is now enclosed within the cylindrical shield 32 and cannot be readily manipulated either manually or with conventional tools. To operate the valve 10, the key 60 is inserted through the open end 34 of the shield 32 to engage the knob 50. Rotation of the key 60 will be transmitted to the key adapter 42 and the valve stem 20 for rotating the valve member 18 within the housing 14. Removal of the key 60 will again deter manipulation of the valve 10.

The foregoing detailed description has been given for clearness of understanding only and no unnecessary limitations should be understood therefrom as some modifications will be obvious to those skilled in the art without departing from the scope and spirit of the appended claims.

What is claimed is:

1. A lock shield assembly adapted to be mounted to a valve having a valve member with a valve stem extending externally of the valve, said lock shield assembly deterring manipulation of the valve member, said lock shield comprising:
a shield member mounted to the valve such that the valve stem extends into said shield member, said shield member having an open end; and
a key adapter received within said shield member and connected to the valve stem such that rotation of said key adapter is transmitted to the valve stem, said key adapter engageable through said open end of said shield member.

2. The shield assembly as defined in claim 1 wherein said shield member has a cylindrical configuration with an end wall.

3. The shield assembly as defined in claim 2 wherein said end wall includes an aperture, the valve stem extending through said aperture in said end wall.

4. The shield assembly as defined in claim 3 wherein said key adapter captures said end wall of said shield member against the valve.

5. The shield assembly as defined in claim 1 wherein said key adapter includes means for manipulating said key adapter, said means adapted to be engaged by a key extending through said open end of said shield member into the interior of said shield member.

6. The shield assembly as defined in claim 5 wherein said key adapter includes a knob, said knob having an external configuration adapted to be engaged by a key extending through said open end of said shield member into the interior of said shield member.

7. A lock shield assembly adapted to be mounted to a valve having a valve member with a valve stem extending externally of the valve, said lock shield assembly deterring manipulation of the valve member, said lock shield comprising:
a cylindrical shield member mounted to the valve, said shield member having an open end and an end wall, the valve stem extending through said end wall into said shield member; and
a key adapter received within said shield member and secured to the valve stem such that rotation of said key adapter is transmitted to the valve stem, said key adapter including a base capturing said end wall of said shield member against the valve and a knob configured to be engaged by a key inserted into said shield member.

8. The shield assembly as defined in claim 7 wherein said key adapter includes means for manipulating said key adapter, said means adapted to be engaged by a key extending through said open end of said shield member into the interior of said shield member.

9. The shield assembly as defined in claim 8 wherein said key adapter knob has an external configuration adapted to be engaged by the key.
